(19) United States
(12) Patent Application Publication
(10) Pub. No.: US 2007/0132848 A1
(43) Pub. Date: Jun. 14, 2007

(54) Photographic device

(75) Inventors: Masayuki Ito, Nagano (JP); Hidefumi Noboritama, Nagano (JP)

Correspondence Address: REED SMITH, LLP;ATTN: PATENT RECORDS DEPARTMENT, 599 LEXINGTON AVENUE, 29TH FLOOR, NEW YORK, NY, 10022-7650, US

(73) Assignee: OPT Corporation

(21) Appl. No.: 11/422,674

(22) Filed: Jun. 7, 2006

(30) Foreign Application Priority Data
Jun. 7, 2005 (JP) JP 2005-166656

(51) Int. Cl. H04N 7/18; H04N 5/262; G08B 13/00

(52) U.S. Cl. 348/152; 348/240.99; 340/541

(57) ABSTRACT

A photographic device including: a wide-angle lens; an image processing unit for processing light passed through the wide-angle lens to convert the light into a wide-field picture, directly cutting out a part of the wide-field picture, and for correcting distortion of the part cut out; and recording means capable of recording the picture corrected for distortion by the image processing unit.

### CROSS-REFERENCES TO RELATED APPLICATION

This application claims priority to Japanese Application No. 2005-166656 filed Jun. 7, 2005, the entire disclosures of which is hereby incorporated by reference.

### BACKGROUND OF THE INVENTION

1. Field of the Invention

The present invention relates to a photographic device which uses a wide-angle lens.

2. Description of the Related Art

Up to now, monitoring systems have been employed by banks, convenience stores, or other such stores, as countermeasures against crimes such as burglary, theft, and sneak theft. A recent increase in the crimes has brought about a gain in popularity of monitoring systems even at general households. As the monitoring system of this type, the inventors of the present invention have proposed a monitoring system, which includes: a sensor for detecting mobile objects approaching into a predetermined range; a mechanism for photographing at least a picture of a detection range by the sensor; a main body for processing an output signal from the sensor and a photographed picture signal; a semiconductor memory medium which is detachably mounted to the body unit and to which the photographed picture is recorded based on a detection signal of the sensor; and a monitor for displaying the photographed picture.

As a monitoring camera, there is known a camera, which includes a standard lens and a wide-angle lens, and switches a lens from the standard to the wide-angle lens to continue monitoring when a front portion the camera is stained.

According to a conventional household monitoring system, a standard lens has been employed as a lens of a photographic device for reasons of lens costs and others. In the case of the standard lens, however, the range of photographing is so narrow that dead angles are easily generated.

Certain types of monitoring systems used at companies or the like employ wide-angle lenses. In this case, however, image processing and image recording must be carried out for all wide-angle pictures. Thus, when an image is stored, a memory having a large storage capacity becomes necessary. A high-speed and high-function circuit also becomes necessary for image processing.

### SUMMARY OF THE INVENTION

It is therefore an object of the present invention to provide a photographic device, which hardly generates dead angles during photographing and enables use of a memory having a small storage capacity.

In order to solve the above problem, according to the present invention, there is provided a photographic device including: a wide-angle lens; an image processing unit for processing light passed through the wide-angle lens to convert the light into a wide-field picture, directly cutting out a part of the wide-field picture, and correcting distortion of the part cut out; and recording means capable of recording the picture corrected for distortion by the image processing unit.

According to the photographic device, as the wide-angle lens is used to take out the wide-field picture, dead angles are hardly generated. Furthermore, as a part of the wide-angle picture is directly cut out to correct the distortion of the cutout part, thereby enabling recording, only a small recording capacity is necessary.

### BRIEF DESCRIPTION OF THE DRAWINGS

In the accompanying drawings:

FIG. 1 is a diagram showing main components of a photographic device and an arrangement relation thereof according to an embodiment of the present invention;

FIG. 2 is a block diagram of a camera system which uses the photographic device of FIG. 1;

FIG. 3 is a partial perspective diagram of the camera system which uses the photographic device of FIG. 1 when it is seen from the front thereof;

FIGS. 4A and 4B are diagrams showing a partial shield can be mounted to the camera system of FIG. 3;

FIGS. 5A to 5D are diagrams showing pictures photographed and recorded by the camera system of FIG. 2;

FIG. 6 is a diagram showing an example of a wide-field picture photographed by the photographic device of FIG. 1 or the camera system of FIG. 2;

FIG. 7 is a diagram showing an example of a wide-field picture divided into four planar pictures by correcting distortion; and

FIGS. 8A and 8B are diagrams showing examples of using the camera systems of FIGS. 2 and 3, in which FIG. 8A shows a state where the camera system is mounted near a house door, and FIG. 8B shows which part of the wide-field picture is cut out.

### DETAILED DESCRIPTION OF THE PREFERRED EMBODIMENTS

A photographic device 1 of an embodiment of the present invention, and a camera system 10 that uses the photographic device 1 will be described below with reference to the drawings. The photographic device 1 or the camera system 10 is used as a household or office monitoring camera. However, it can be applied to a field of conference scene photographing, production inspection, remote observation or the like in addition to the monitoring camera.

In appearance, the photographic device 1 mainly includes a compact cubic body (not shown) having a length of one side set to, e.g., 3 cm, and a wide-angle lens 2 which slightly projects from the body. The wide-angle lens 2 is a flat lens but capable of wide-angle photographing of 180°.

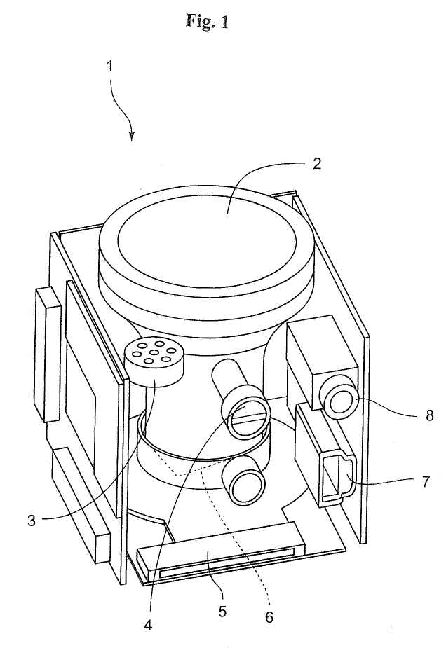

As shown in FIG. 1, in addition to the wide-angle lens 2, the photographic device 1 includes a microphone 3, a focus adjustment knob 4, a controller interface 5 into which a flexible circuit board is inserted, an imaging device 6 which becomes an image sensor, a USB terminal unit 7 which receives a universal serial bus (USB) terminal, and a signal output unit 8 for outputting a video or audio signal. By adding motion detection means described blow, the photographic device 1 having such a compact body can be set as a photographic device equipped with a state change detection function. By adding recording means, it can also be set as a photographic device equipped with a recording function. By adding display means for displaying a photographed picture, it can further be set as a photographic device equipped with a display function.

A front which becomes an incident side of the wide-angle lens 2 has a swell about equal to that of a normal convex lens. However, the wide-angle lens 2 is formed into a roughly planar shape as a whole. An inside glass of the wide-angle lens 2 is subjected to ingenious processing to enable photographing at 90° all around with respect to an optical axis at the wide-angle lens 2. In other words, the wide-angle lens 2 has a view angle (=field angle) of 180°, and enables photographing of a picture all around the optical axis (i.e., all-around picture of 360°).

The microphone 3 captures a sound of monitoring target place. The focus adjustment knob 4 is used for focus adjustment when the photographic device 1 is installed. A flexible circuit board for control is inserted into the controller interface 5. The imaging device 6 (image sensor 6 hereinafter) is, for example, a CMOS image sensor for converting a light passed through the wide-angle lens 2 into an electric signal. As the image sensor 6, in place of the CMOS image sensor, a CCD sensor or other imaging device may be used.

The photographic device 1 can be connectable to a computer such as a notebook computer through a predetermined USB cable inserted into the USB terminal unit 7. When it is connected to the computer, the photographic device 1 receives power supply from the computer, and transfers and receives data with the computer. Even when there is no USB cable inserted into the USB terminal unit 7, the photographic device 1 can output data through a predetermined cable inserted into the signal output unit 8. In other words, the signal output unit 8 is used for outputting data of the photographic device 1 side.

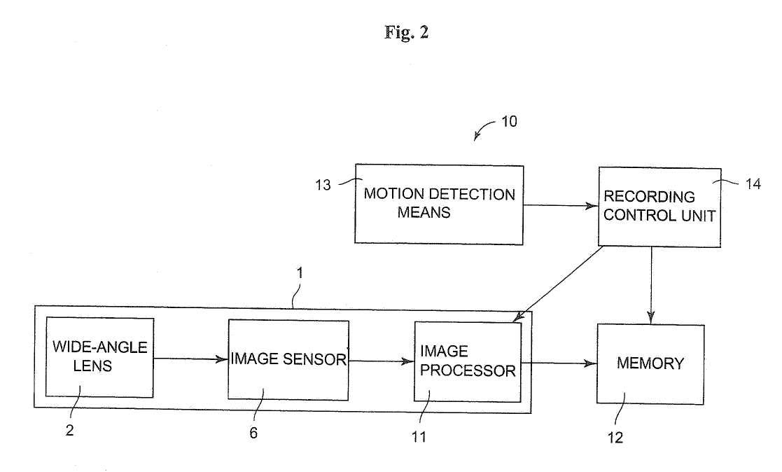

FIG. 2 is a block diagram of the camera system 10 which includes the photographic device 1, specifically showing a photographic device equipped with a recording function and a state change detection function.

As shown in FIG. 2, an internal circuit of the photographic device 1 includes the image sensor (imaging device) 6 for detecting a light passed through the wide-angle lens 2, and an image processor 11 for processing a signal from the image sensor 6 to convert it into a wide-field picture, or cutting out a part thereof to correct distortion. The image sensor 6 and the image processor 11 constitute an image processing unit.

In the camera system 10, a memory 12 as recording means, motion detection means 13, and recording control unit 14 are added to the photographic device 1. According to the embodiment, the memory 12 is instructed by the recording control unit 14 to record a planar image subjected to distortion correction at the image processor 11. According to the embodiment, the motion detection means 13 is an infrared ray detection sensor for detecting a change made in infrared ray when a human body or the like different in temperature from the surroundings moves. The recording control unit 14 designates an area to be subjected to distortion correction to the image processor 11, and instructs recording to the memory 12.

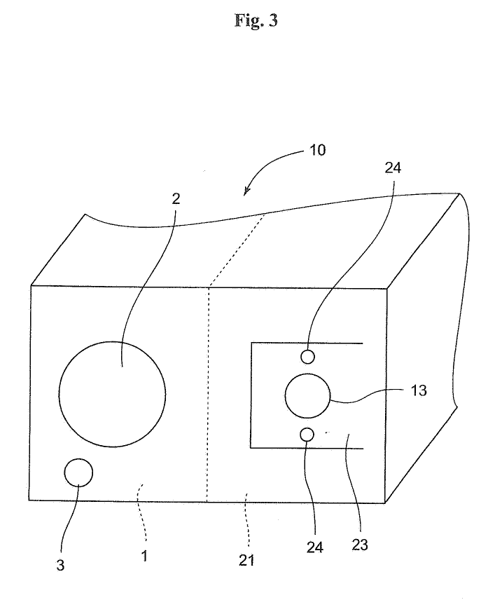

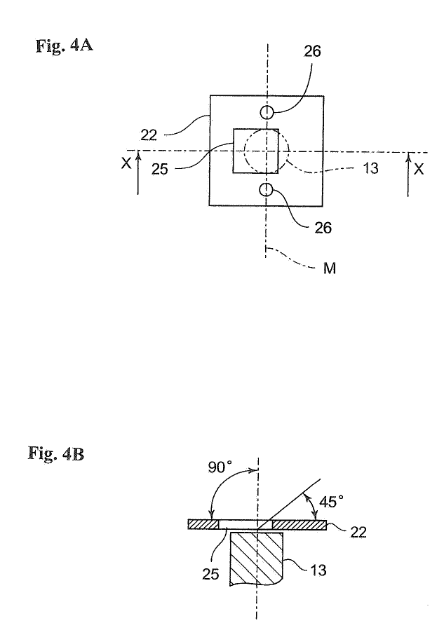

FIG. 3 shows a specific example of the camera system 10. This camera system 10 mainly includes the photographic device 1 and a detection unit 21. The motion detection means 13 constituted of the infrared ray detection sensor, the memory 12, and the recording control unit 14 are arranged in the detection unit 21. On the front side of the detection unit 21, a mounting unit 23 is disposed to mount a partial shield 22 shown in FIG. 4A. The mounting unit 23 has screw holes 24 and 24 bored to mount the partial shield by screws (not shown).

As shown in FIG. 4A, the partial shield 22 is a square plate, and has a small square through-hole 25 formed roughly in the center. The partial shield 22 has two screw holes 26 and 26 bored by sandwiching the through-hole 25. The through-hole 25 is set in a position eccentric to a center line M of the partial shield 22. Accordingly, as shown in FIG. 4A, for example, when the partial shield 22 is mounted to the front of the detection unit 21, about ¼ of the right side of the front of the motion detection means 13 is covered with the partial field 22. FIG. 4B is a diagram showing a section cut on a line X-X of FIG. 4A.

In a state of FIGS. 4A and 4B, when seen from the motion detection means 13 side, as shown in FIG. 4B, an area which becomes undetectable (=dead angle) at an angle of about 45° is generated on the left side (right side of FIG. 4A) . In other words, on the right side seen from the motion detection means 13 (left side of FIG. 4A), as shown in FIG. 4B, motion of a human or an animal can be detected in a range of 90°. However, a dead angle is generated on the left side. When the partial shield 22 is mounted upside down, the left and right sides of the partial shield 22 are reversed. So when seen from the motion detection means 13, a dead angle is generated on the right side. The partial shield 22 may not be mounted to the mounting unit 23. In this case, almost no dead angle is generated in the motion detection means 13.

Next, an operation of the camera system 10 thus configured will be described.

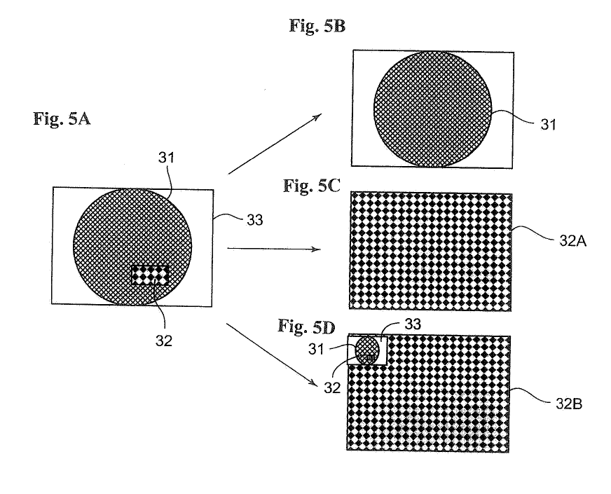

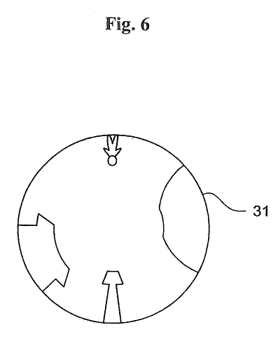

The motion detection means 13 always detects whether a human or an animal comes into a detection range or not. Rather than constant detection, the motion detection means 13 may execute detection only for a predetermined time by designating a detection hour (time). The photographic device 1 always creates a wide-field picture 31 (refer to FIG. 5A) by the image processing unit. For example, this wide-field picture 31 is a circular picture similar to that shown in FIG. 6. It becomes a more distorted picture toward the outside of a diameter direction. Additionally, a predetermined area 32 (refer to FIG. 5A) in the detection range of the motion detection means 13 is set as a section for correcting distortion.

This setting is carried out by the recording control unit 14. However, the predetermined area may be set beforehand in the photographic device 1, or by a unit other than the recording control unit 14. Without this area setting, a direction of a human or the like which enters the detection range may be detected and, based on a result of the detection, the predetermined area 32 may be set for each generation of a detection signal which is described below.

When an animal such as a human comes into the detection range, the motion detection means 13 detects it. The motion detection means 13 generates a detection signal and outputs it to the recording control unit 14. Upon reception of the detection signal, the recoding control unit 14 instructs the image processor 11 to cut out the predetermined area 32 and to correct distortion of a picture of the predetermined area 32.

In addition to the above instructions, the recording control unit 14 instructs the memory 12 to record a picture 32A (refer to FIG. 5C) which is a distortion-corrected planar image. The motion detection means 13 is turned ON (generates detection signal) when a human or an animal comes into the detection range, and turned OFF when the human or the like stops its motion. When the human or the like starts its motion again, the motion detection means 13 is turned ON again to generate a detection signal, and a distortion-corrected picture is recorded again in the memory 12. When a human or the like continues its motion in the detection range, the camera system 10 generates detection signals at predetermined time intervals to continue intermittent recording of the picture 32A. Thus, the distortion-corrected picture 32A alone is recorded in the memory 12.

According to the embodiment, the photographic device 1 is always ON to constantly process the wide-field pictures. However, the photographic device 1 may be driven only when the motion detection means 13 generates a detection signal. The photographic device 1 may operate only for a time equal to the detection time of the motion detection means 13.

A dead angle is difficult to be generated in the case of this photographic device 1 because of its use of the wide-field lens 2 to take out the wide-field picture. Only a small recording capacity is necessary as a part of the wide-field picture is directly cut out, and only the cutout part is subjected to distortion correction to be recorded. The camera system 10 includes the motion detection means 13 for generating a detection signal, and operates the memory 12 when the detection signal is generated. In other words, upon an entry of a human or the like into the detection area, the motion detection means 13 is operated to generate a detection signal. After the generation of the detection signal, the memory 12 records a predetermined and distortion-corrected picture. Accordingly, a recording capacity becomes overwhelmingly smaller as compared with that during continuous recording.

According to the photographic device 1 or the camera system 10, when the picture of the predetermined area 32 is enlarged, it is not enlarged after creation of a planar image of the predetermined area 32, but it is enlarged by using an original image of the predetermined area 32. Hence, the enlarged image becomes fine and beautiful.

The preferred embodiment of the present invention has been described. However, various changes can be made without departing from the spirit and scope of the invention. For example, the wide-field picture 31 is an image of a field angle 180° all around at 360°. However, a field angle may be set in a range of 120° to 240°. In any case, a wide-field picture is obtained by using the wide-angle lens and executing photographing wider in angle than normal camera photographing.

As shown in FIG. 5B, pictures recorded in the memory 12 may be wide-field picture 31 itself in addition to the distortion-corrected picture corresponding to the predetermined area 32. In other words, the recording control unit 14 may instruct the memory 12 to select recording of one or both of the distortion-corrected picture 32A and the wide-field picture 31. In this case, the selection instruction of the recording control unit 14 enables a user to properly record the wide-field picture 31 or the distortion-corrected picture 32A as the user wishes.

As shown in FIG. SD, a picture recorded in the memory 12 may be a composite picture 32B obtained by incorporating an original picture 33 containing the wide-field picture 31 in the distortion-corrected picture 32A of the predetermined area 32. In this case, a positional relation of the distortion-corrected picture among all the pictures can be understood at a glance.

When the detection signal is generated, the two pictures, i.e., the distortion-corrected picture 32A and the wide-field picture 31, may be continuously recorded in the memory 12. In other words, when the detection signal is generated, preferably, at least two pictures of a distortion-corrected picture and a wide-field picture are recorded. This way, as the planar picture of the predetermined part and the wide-ranging wide-field picture are recorded, a positional relation of the predetermined part is defined to record the picture. In this case, the wide-field picture 31 may be one which defines the predetermined area 32 such as FIG. 5A or only the wide-field picture 31 such as FIG. 5B. When the detection signal is generated, two or more pictures may be recorded. In this case, two or more pictures 32A may be recorded at small time intervals, two or more composite pictures 32B may be recorded, two or more of mixtures thereof may be recorded, or two or more of the wide-field picture 31 and one of other pictures 32A and 32B or a combination thereof may be recorded.

The selection of the recording in the memory 12 is instructed by the recording control unit 14. In other words, according to the embodiment, all the recording operations are carried out by the recording control unit 14. However, the motion detection means 13 and the recording control unit 14 are not always necessary. For example, for the photographic device 1, one or more predetermined areas may be set beforehand, and pictures of the predetermined areas may be sequentially cut out at each predetermined time interval, and recorded in the memory 12 after correction of distortion of the cutout parts.

According to the embodiment, the recording control unit 14 can set the predetermined area 32 in a position corresponding to the detection range of the motion detection means 13. In other words, the predetermined area 32 can be freely set in any position by the recording control unit 14. Based on an instruction from the recording control unit 14, the predetermined area 32 can be plural, enlarged, reduced, and moved in a circumferential or radial direction.

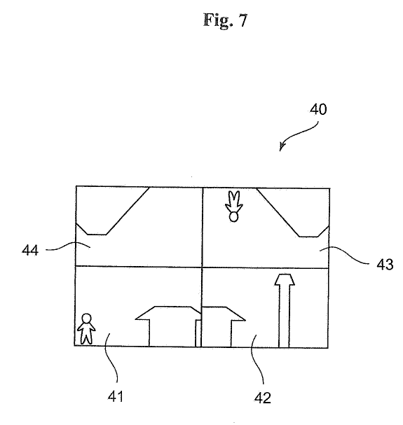

As shown in FIG. 7, the picture recorded in the memory 12 may be pictures 40 obtained by dividing a wide-field picture 31 into four and correcting distortion thereof. It may be a picture obtained by dividing the wide-field picture into three, five, six or the like. As shown in FIG. 7, in the case of the divided pictures, it is preferable that the divided pictures have images having overlapped parts. In other words, divided screens 41 and 42 contain the same part of a house image. Similarly, human images appear in the two divided screens 41 and 43, and the two divided screens 43 and 44 contain the same part of a mountain image.

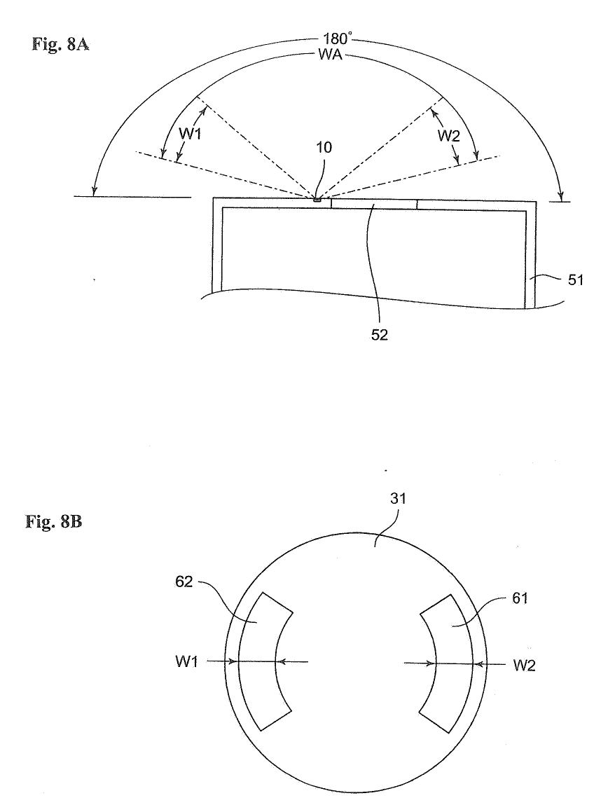

As shown in FIGS. 8A and 8B, the camera system 10 may be installed near a door 52 of a house 51, and predetermined areas set by the recording control unit 14 may be first and second areas 61 and 62 arranged in symmetrical positions of roughly 180°. In this case, as shown in FIG. 8A, preferably, a detection range of the motion detection means 13 is set to about 180° to prevent generation of dead angles of the detection range in both left and right directions of the door 52. An angle WA of FIG. 8A may be set as a detection range of the motion detection means 13.

Generally, a person with illegal intent such as mischief stands not in the front of the door 52 but in a position near the house 51 on the side of the door 52 trying to be out of a photographing range of a camera lens as indicated by areas W1 and W2 in FIG. 8A. As shown in FIG. 8B, by setting predetermined areas of the camera lens 10 installed in the house 51 to be first and second areas 61 and 62 which cover the areas W1 and W2, humans or the like in the positions W1 and W2 of FIG. 8A can be captured by distortion-corrected pictures to be recorded. In addition to the first and second areas 61 and 62, a small circular area may be added therebetween, and this circular area may be set as an area to be corrected for distortion.

Regarding the motion detection means for detecting a state change to generate a detection signal, in addition to a human detection sensor such as an infrared ray detection sensor, any types can be used as long as they detect state changes, such as means for detecting an operation of an interphone or a door bell, or means for detecting insertion of an IC card or the like into a card reader disposed in the door or the like. In other words, any types that detect motion, pressing, entry, and a sound may be used.

The detection range of the motion detection means 13 can be set equal to a wide view field of the wide-field lens 2, or a part of the side view field of the wide-field lens 2. The detection range of the motion detection means 13 may set to detect a field outside the wide view field while it is partially overlapped with the wide view field of the wide-field lens 2, or to completely cover the wide view field of the wide-field lens 2 and to detect a field outside the wide view field.

Display means may be added to the photographic device 1 or the camera system 10 to display a picture processed by the image processor 11. In this case, a recording mistake or the like can be prevented as an image to be recorded can be checked by the display means. This display means may display a distortion-corrected picture alone. The display means may display at least one of the distortion-corrected picture and the wide-field picture. When both pictures can be displayed, preferably, a mode of always displaying a picture (e.g., wide-field image) as a moving image and a mode of displaying a picture (e.g., distortion-corrected picture (planar picture) or wide-field picture) only when a detection signal is generated are permitted to be switched. When neither of the pictures can be displayed, preferably, the mode of always displaying a picture and the mode of displaying a picture only when the detection signal is generated are permitted to be switched. Accordingly, usability for a user is improved. A speaker for outputting a sound captured through the microphone 3 may be added to the display means. With this configuration, not only a picture but also a sound can be output creating a more favorable situation for a user. A speaker may be added to the photographic device 1.

According to the embodiment, the image processing unit processes the light passed through the wide-field lens 2 to obtain a wide-field picture. However, after setting of the predetermined area 32, without executing a process for obtaining a wide-field picture, distortion correction only of a pixel (image) of the predetermined area 32 may be carried out, and the distortion-corrected picture may be output.

When the picture is recorded in the memory 12, a recording or photographing time may be recorded inside/outside the picture. For the memory 12 as recording means, a semiconductor memory such as a flash memory is preferable. However, an optical recording medium such as a CD-R or a DVD-RAM, or a magnetic recording medium such as a hard disk may be employed. A newly developed special lens is employed for the wide-field lens 2. However, a conventional fisheye lens, or a wide-field lens such as a lens disclosed in JP 2003-30335 A, i.e., a lens having a reflection surface in a top part, may be used.

For the distortion correction, for example, a method of correcting distortion by mapping a texture of the wide-field picture on a spherical surface is employed. However, other well-known methods can be employed. The image processor 11 is a so-called image processing processor. The image processing is carried out by hardware. However, it may be executed by software. For the hardware, an application specific integrated circuit (ASIC), a field programmable gate array (FPGA) which allows easy change of a hardware configuration, or the like can be used.

As described above, according to the photographic device of the present invention, dead angles are difficult to be generated during photographing, and a memory having a small storage capacity can be used.

What is claimed is:

1. A photographic device, comprising:
a wide-angle lens;
an image processing unit for processing light passed through the wide-angle lens to convert the light into a wide-field picture, directly cutting out a part of the wide-field picture, and for correcting distortion of the part cut out; and
recording means capable of recording a picture corrected for distortion by the image processing unit.

2. A photographic device according to claim 1, further comprising a recording control unit for designating the part to be cut out and instructing the recoding means to execute recording,
wherein the recording control unit instructs selection of recording of one or both of the picture corrected for distortion and the wide-field picture.

3. A photographic device according to claim 1, further comprising motion detection means for detecting a state change to generate a detection signal,
wherein the recording means is operated when the detection signal is generated.

4. A photographic device according to claim 2, further comprising motion detection means for detecting a state change to generate a detection signal,
wherein the recording means is operated when the detection signal is generated.

5. A photographic device according to claim 3, wherein at least the picture corrected for distortion and the wide-field picture are recorded when the detection signal is generated.

6. A photographic device according to claim 4, wherein at least the picture corrected for distortion and the wide-field picture are recorded when the detection signal is generated.

7. A photographic device according to claim 5, wherein a picture containing the wide-field picture in a part of the picture corrected for distortion is recorded.

8. A photographic device according to claim 6, wherein a picture containing the wide-field picture in a part of the picture corrected for distortion is recorded.

9. A photographic device according to claim 1, further comprising display means for displaying the picture corrected for distortion,
wherein the picture to be recorded is displayed on the display means.

10. A photographic device according to claim 2, further comprising display means for displaying the picture corrected for distortion,
wherein the picture to be recorded is displayed on the display means.

11. A photographic device according to claim 3, further comprising display means for displaying the picture corrected for distortion,
wherein the picture to be recorded is displayed on the display means.

12. A photographic device according to claim 4, further comprising display means for displaying the picture corrected for distortion,
wherein the picture to be recorded is displayed on the display means.

13. A photographic device according to claim 5, further comprising display means for displaying the picture corrected for distortion,
wherein the picture to be recorded is displayed on the display means.

14. A photographic device according to claim 6, further comprising display means for displaying the picture corrected for distortion,
wherein the picture to be recorded is displayed on the display means.

15. A photographic device according to claim 7, further comprising display means for displaying the picture corrected for distortion,
wherein the picture to be recorded is displayed on the display means.

16. A photographic device according to claim 8, further comprising display means for displaying the picture corrected for distortion,
wherein the picture to be recorded is displayed on the display means.

17. A photographic device according to claim 3, further comprising display means for displaying at least one of the picture corrected for distortion and the wide-field picture,
wherein the display means is configured to switch between a mode of always displaying the picture and a mode of displaying the picture only when the detection signal is generated.

18. A photographic device according to claim 4, further comprising display means for displaying at least one of the picture corrected for distortion and the wide-field picture,
wherein the display means is configured to switch between a mode of always displaying the picture and a mode of displaying the picture only when the detection signal is generated.
